(19) United States
(12) Patent Application Publication
(10) Pub. No.: US 2010/0129030 A1
(43) Pub. Date: May 27, 2010

(54) Universal Optical Splitter Modules and Related Mounting Brackets, Assemblies and Methods

(76) Inventors: William J. Giraud, Azle, TX (US); Daniel S. McGranahan, Fort Worth, TX (US); Karyne P. Prevratil, Watauga, TX (US)

Correspondence Address: CORNING INCORPORATED, INTELLECTUAL PROPERTY DEPARTMENT, SP-TI-3-1, CORNING, NY, 14831, US

(21) Appl. No.: 12/625,341

(22) Filed: Nov. 24, 2009

Related U.S. Application Data
(60) Provisional application No. 61/117,471, filed on Nov. 24, 2008.

(51) Int. Cl. G02B 6/26; G02B 6/36; G02B 6/46

(52) U.S. Cl. 385/50; 385/134

(57) ABSTRACT

Optical splitter modules and related mounting brackets, assemblies, and methods for mounting optical splitter modules in fiber optic equipment housings are disclosed. In certain embodiments, the optical splitter modules can be configured to be “universal,” if desired, meaning they are configured to employ certain common or similar dimensions or form factors. In this manner, the optical splitter modules can be installed in different types of fiber optic equipment housings that would otherwise support different form factors. The optical splitter modules are configured to be disposed and supported in different types of fiber optic equipment housings by being configured to be received in a mounting bracket. The mounting bracket is designed to support the form factor of the universal optical splitter module, but also configured to be compatibly installed in a particular type of fiber optic equipment housing in which the optical splitter module is desired to be installed.

### RELATED APPLICATION

The present application claims priority to U.S. Provisional Patent Application Ser. No. 61/117,471 filed on Nov. 24, 2008 entitled “Universally Compatible Splitter Modules,” which is incorporated herein by reference in its entirety.

### BACKGROUND

The field of the disclosure relates generally to optical fiber components, and more particularly to optical splitter modules compatible for mounting in fiber optic equipment housings, chassis, cabinets, racks, and the like.

### Technical Background

Optical fiber is increasingly being used for a variety of broadband applications including voice, video, and data transmissions. Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point.

Fiber optic equipment is located in data distribution centers or central offices to support optical fiber interconnections as part of fiber optic networks. In this regard, these fiber optic networks typically include various fiber optic components to facilitate the provision of optical signals to multiple subscribers in an expedient and economically feasible manner. One of these fiber optic components is an optical splitter. An optical splitter is operable for receiving an optical signal and splitting the optical signal into multiple optical signals. The optical splitter is typically housed in a module housing to form an optical splitter module. The optical splitter module may configured to support one or more input fiber optic adapters to facilitate connection of one or more pre-connectorized input optical fibers carrying optical signals to be split into multiple optical signals. The multiple optical signals may then be carried over multiple output optical fibers optically connected to output fiber optic adapters also supported by the optical splitter module. The input and output optical fibers connected to the optical splitter module may be provided in fiber optic cables.

Because optical splitter modules are typically housed in many different styles and sizes of fiber optic equipment enclosures, housings, cabinets, racks, and the like, different form factors of optical splitter modules are provided. The type of optical splitter module selected for installation is based on the desired splitter capacity and the optical splitter module's compatibility with the particular fiber optic equipment housing in which the optical splitter module is employed. The form factor of the optical splitter module must be compatible to be installed in the fiber optic equipment housing for proper installation. However, providing optical splitter modules that may only be compatible with a certain type of fiber optic equipment housings, thus limiting flexibility in choice and increasing costs by requiring different variation of optical splitter modules to be provided and stocked.

The type of optical splitter module selected for installation may also be based on the needed or desired splitting capacity. For example, if an eight (8) fiber split is required, a 1×8 splitter module may be employed that is configured to split an input optical signal into up to eight (8) output optical signals. If a sixteen (16) fiber split is required, a 1×16 splitter module may be employed that is configured to split an input optical signal into up to sixteen (16) output optical signals. Higher capacity optical splitter modules may be employed even if their capacity is not initially fully utilized, so that when increased splitting capacity is required, replacement of the lower capacity optical splitter module with a higher capacity optical splitter module is not required. However, employing optical splitter modules that include initially unused splitting capacity increases initial cost. Not only are higher capacity splitters modules more expensive in terms of the cost of the splitter module itself, but higher capacity splitters also typically include larger form factors and thus take up more space in fiber optic equipment housings. As a result, additional fiber optic equipment housings and the space necessary to store the additional fiber optic equipments housings would be required.

### SUMMARY OF THE DETAILED DESCRIPTION

Embodiments disclosed herein include optical splitter modules and related mounting brackets, assemblies, and methods. The optical splitter modules may be configured to be mounted in different types of fiber optic equipment housings. The optical splitter modules are configured to split input optical signals into multiple output optical signals for any optical splitting applications desired. In embodiments disclosed herein, the optical splitter modules can be configured to be “universal,” meaning they are configured to employ certain common or similar dimensions or form factors. In this manner, the optical splitter modules can be installed in different types of fiber optic equipment housings that would otherwise support different form factors of optical splitter modules. In this manner, providing different types of optical splitter modules with different form factors may not be necessary.

In disclosed embodiments, the optical splitter modules are configured to be disposed and supported in a fiber optic equipment housing(s) by being configured to be received in compatible mounting bracket(s) that are also compatible with the fiber optic equipment housing(s) employed. The mounting bracket is designed to support the form factor of the optical splitter module and also configured to be compatibly installed in a particular type of fiber optic equipment housing selected. Thus, when it is desired to install the optical splitter module in a particular type of fiber optic equipment housing, a mounting bracket compatible with the selected fiber optic equipment housing can be employed to install the optical splitter module in such fiber optic equipment housing. The optical splitter modules and mounting brackets disclosed herein are also configured to provide for flexible and easy installation, access, operation, maintenance, and de-installation of optical splitter modules. The mounting brackets disclosed herein can also facilitate initial installation of the optical splitter modules according to initial splitting capacity needs, and the ability to easily add additional optical splitter modules to provide increased splitting capacity subsequently without requiring the de-installation, reconfiguration, or disposal of the initially installed optical splitter modules.

In this regard, in one embodiment, an optical splitter module is provided. The optical splitter module includes a module housing. An optical splitter is positioned in the module housing. At least one input fiber optic adapter is disposed in a first end of the module housing and optically connected to an input of the optical splitter. A plurality of output fiber optic adapters are disposed in a second end of the module housing opposite the first end of the module housing. The optical splitter is configured to split an optical signal carried over an input optical fiber connected to the at least one input fiber optic adapter into a plurality of optical signals provided to the plurality of output fiber optic adapters. At least one recessed portion is disposed in the module housing between the first end and the second end. The module housing can be configured to be received within a receiving area of a mounting assembly for flexible and easy installation, access, operation, maintenance, and de-installation. In certain embodiments, the recessed portion of the module hosing may be configured to be received within the receiving area of the mounting assembly.

In another embodiment, an optical splitter assembly is provided. The optical splitter assembly includes one or more optical splitter modules. Each of the optical splitter modules includes a module housing, an optical splitter positioned in the module housing, and at least one recessed portion disposed in and between a first end of the module housing and a second end of the module housing opposite the first end of the module housing. The assembly also includes at least one mounting assembly forming at least one receiving area. The at least one receiving area is configured to receive the module housing of at least one of the one or more optical splitter modules. In certain embodiments, the at least one receiving area is configured to receive the at least one receiving area of the module housing.

Methods for installing an optical splitter module in a fiber optic equipment housing are also disclosed. In one embodiment, the method includes providing a module housing having at least one recessed portion disposed between a first and second end of the module housing. The method further includes disposing the module housing into a receiving area of a mounting assembly. The mounting assembly is installed in the fiber optic equipment housing to install the optical splitter module in the fiber optic equipment housing. The mounting assembly can be installed in the fiber optic equipment housing prior to disposing the module housing in the receiving area of the mounting assembly, or after the module housing is disposed in the receiving area of the mounting assembly.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a front perspective view of an exemplary embodiment of optical splitter modules installed in panels installed in an exemplary fiber optic equipment housing;

FIGS. 2A-2C are perspective, side, and top views, respectively, of the optical splitter modules illustrated in FIG. 1 configured to be installed in a panel configured to be installed in the fiber optic equipment housing of FIG. 1;

FIG. 3 is a front view of the panel in FIGS. 1-2C configured to receive and support two optical splitter modules according to FIGS. 2A-2C for installation into the fiber optic equipment housing of FIG. 1;

FIG. 4 is a perspective view of the two optical splitter modules according to FIGS. 2A-2C disposed through and supported by the panel of FIG. 3 configured to be installed in the fiber optic equipment housing of FIG. 1;

FIG. 5 is a front perspective view of an exemplary embodiment of the optical splitter modules of FIGS. 2A-2C installed in an alternative exemplary mounting assembly mounted in an alternative fiber optic equipment housing;

FIGS. 6A and 6B are perspective and front views, respectively, of exemplary mounting brackets employed in the mounting assembly of FIG. 5;

FIG. 7 is a rear perspective view of optical splitter modules of FIGS. 2A-2C installed between opposing mounting brackets of FIGS. 6A and 6B mounted in the fiber optic equipment housing of FIG. 5;

FIG. 8 is a front perspective view of alternative exemplary optical splitter modules installed between alternative exemplary mounting assemblies containing mounting platforms and mounted in the fiber optic equipment housing of FIG. 5;

FIG. 9 is a perspective view of the exemplary optical splitter module in FIG. 8;

FIG. 10 is a perspective view of the exemplary mounting assembly in FIG. 8 configured to receive the optical splitter module of FIG. 9 in mounting platforms disposed therein to be mounted in the fiber optic equipment housing in FIG. 8;

FIG. 11 is a perspective view of the optical splitter module of FIG. 9 disposed in a lift-up carrier mounting assembly configured to be installed in the fiber optic equipment housing of FIG. 8; and

FIG. 12 is a perspective view of the lift-up carrier mounting assembly with optical fiber modules installed therein mounted in the fiber optic equipment housing of FIG. 8.

### DETAILED DESCRIPTION

Reference will now be made in detail to the certain embodiments of the present disclosure, examples of which are illustrated in the accompanying drawings, in which some, but not all embodiments are shown. Indeed, the concepts may be embodied in many different forms and should not be construed as limited to the embodiments set forth herein; rather, these embodiments are provided so that this disclosure will satisfy applicable legal requirements. The embodiments and methods described herein are suitable for making optical connections for short distance optical networks. The concepts of the disclosure advantageously allow the simple, quick, and economical connection and disconnection of glass optical fibers. Reference will now be made in detail to the preferred embodiments, examples of which are illustrated in the accompanying drawings. Whenever possible, like reference numbers will be used to refer to like components or parts.

Embodiments disclosed herein include optical splitter modules and related mounting brackets, assemblies, and methods. The optical splitter modules may be configured to be mounted in different types of fiber optic equipment housings. The optical splitter modules are configured to split input optical signals into multiple output optical signals for any optical splitting applications desired. In embodiments disclosed herein, the optical splitter modules can be configured to be “universal,” meaning they are configured to employ certain common or similar dimensions or form factors. In this manner, the optical splitter modules can be installed in different types of fiber optic equipment housings that would otherwise support different form factors of optical splitter modules. In this manner, providing different types of optical splitter modules with different form factors may not be necessary.

In disclosed embodiments, the optical splitter modules are configured to be disposed and supported in a fiber optic equipment housing(s) by being configured to be received in compatible mounting bracket(s) that are also compatible with the fiber optic equipment housing(s) employed. The mounting bracket is designed to support the form factor of the optical splitter module and also configured to be compatibly installed in a particular type of fiber optic equipment housing selected. Thus, when it is desired to install the optical splitter module in a particular type of fiber optic equipment housing, a mounting bracket compatible with the selected fiber optic equipment housing can be employed to install the optical splitter module in such fiber optic equipment housing. The optical splitter modules and mounting brackets disclosed herein are also configured to provide for flexible and easy installation, access, operation, maintenance, and de-installation of optical splitter modules. The mounting brackets disclosed herein can also facilitate initial installation of the optical splitter modules according to initial splitting capacity needs, and the ability to easily add additional optical splitter modules to provide increased splitting capacity subsequently without requiring the de-installation, reconfiguration, or disposal of the initially installed optical splitter modules.

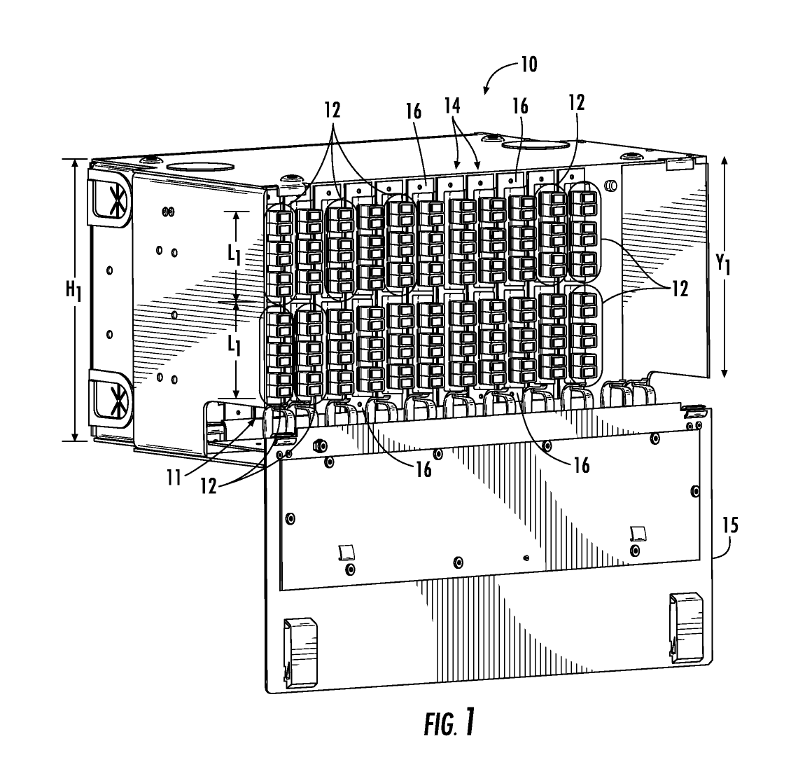

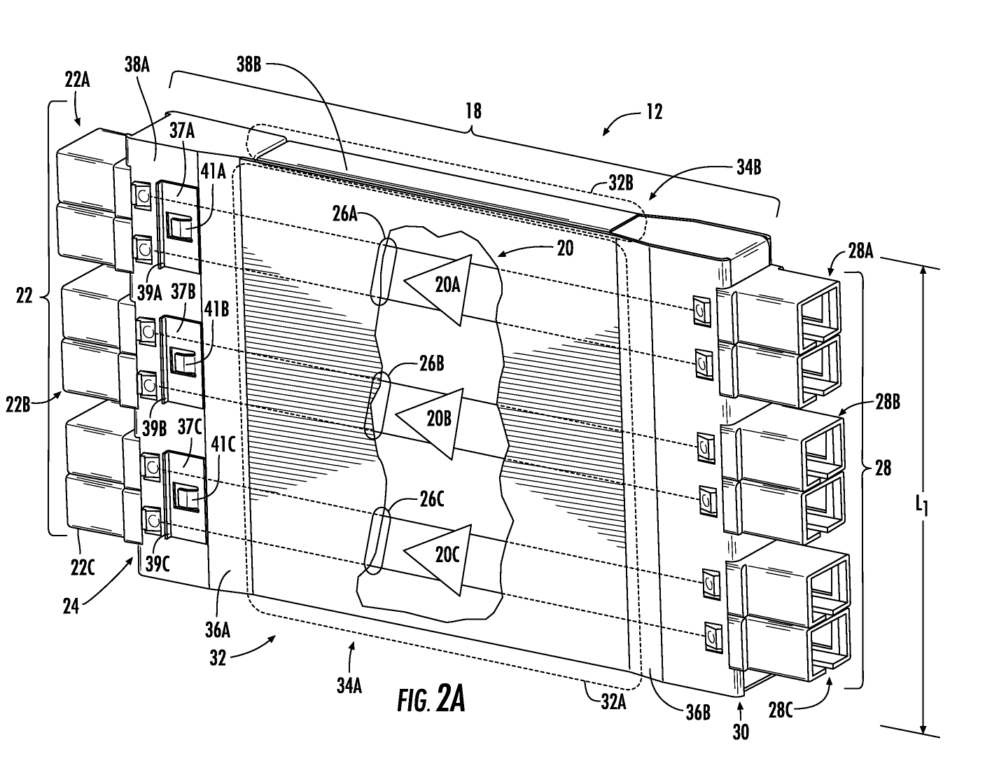

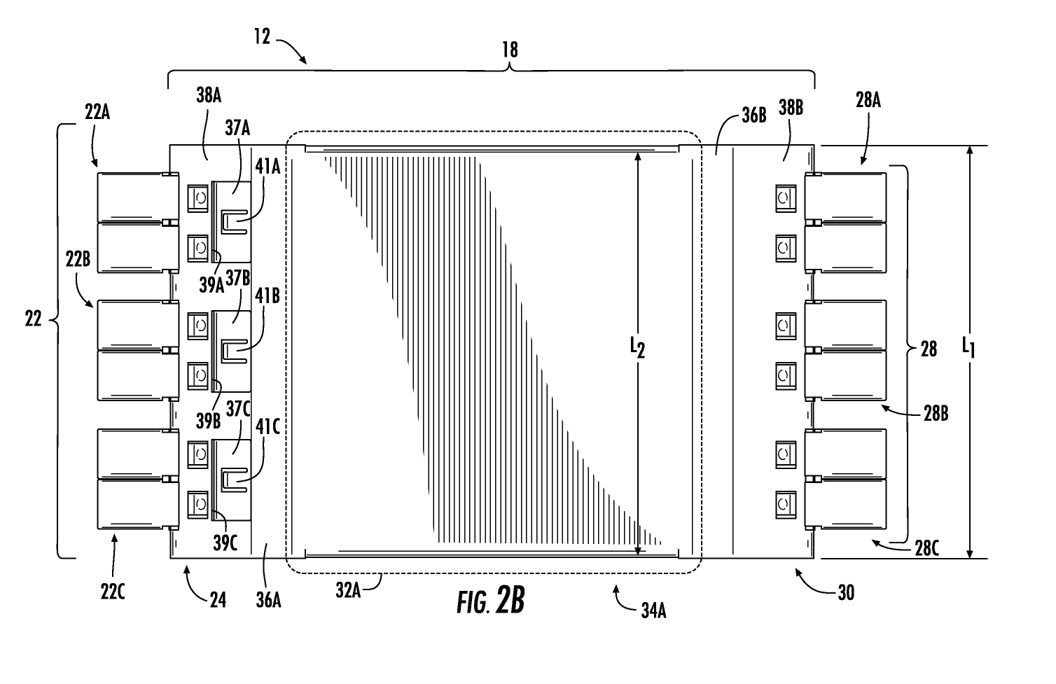

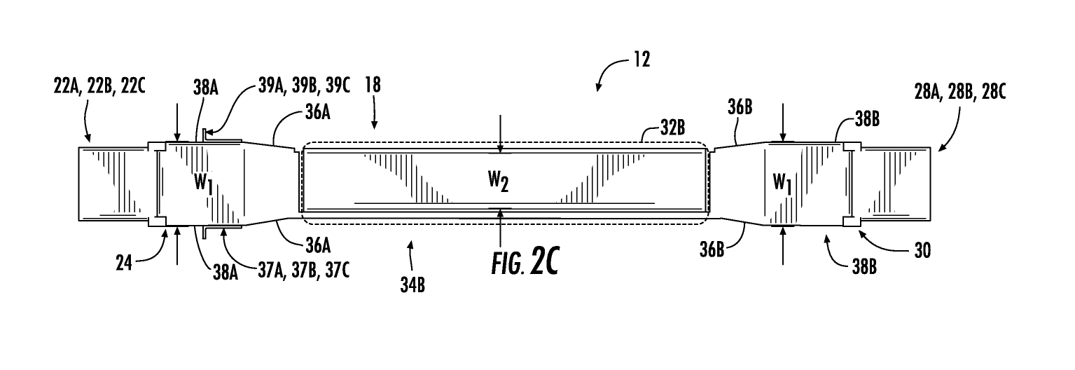

In this regard, FIG. 1 is a front perspective view of one exemplary embodiment of optical splitter modules installed in panels that are installed in an exemplary fiber optic equipment housing. In this regard, a fiber optic equipment housing 10 is provided, as illustrated in FIG. 1. The fiber optic equipment housing 10 may be a chassis, enclosure or other housing that forms an internal compartment 11 configured to hold fiber optic equipment, such as optical splitter modules 12. Other types of fiber optic equipment may also be housed in the fiber optic equipment housing 10, such as fiber optic connection modules and fiber optic patch panels, as examples. The fiber optic equipment housing 10 in this embodiment has a height H₁ equal to 4 unit sizes (U) (4-U). A “U” unit size is approximately 1.75 inches in height in this embodiment. The fiber optic equipment housing 10 may be of any other size desired. A door 15 may be installed on the fiber optic equipment housing 10 that is configured to open and close about the fiber optic equipment housing 10 to open and close off access to the internal compartment 11 inside the fiber optic equipment housing 10. More details regarding the exemplary optical splitter modules 12 installed in the fiber optic equipment housing 10 of FIG. 1 are discussed below with regard to FIGS. 2A-2C.

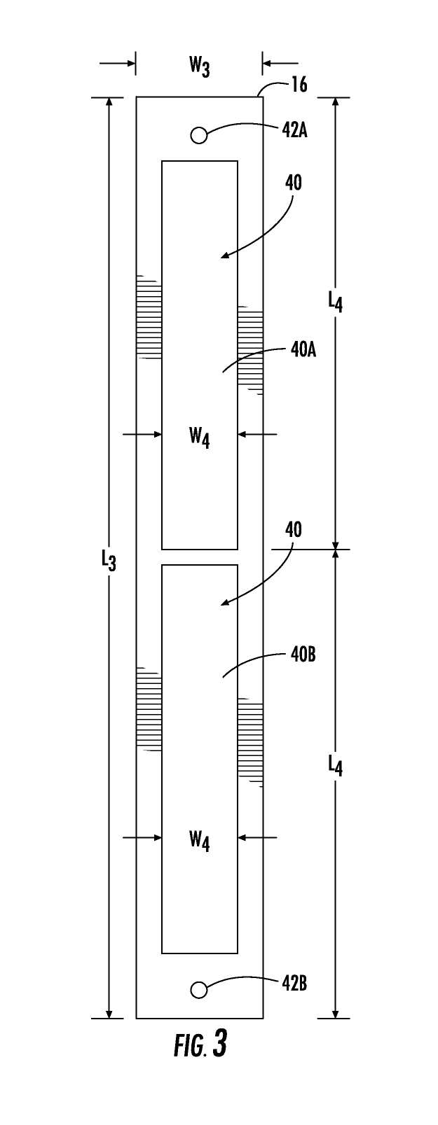

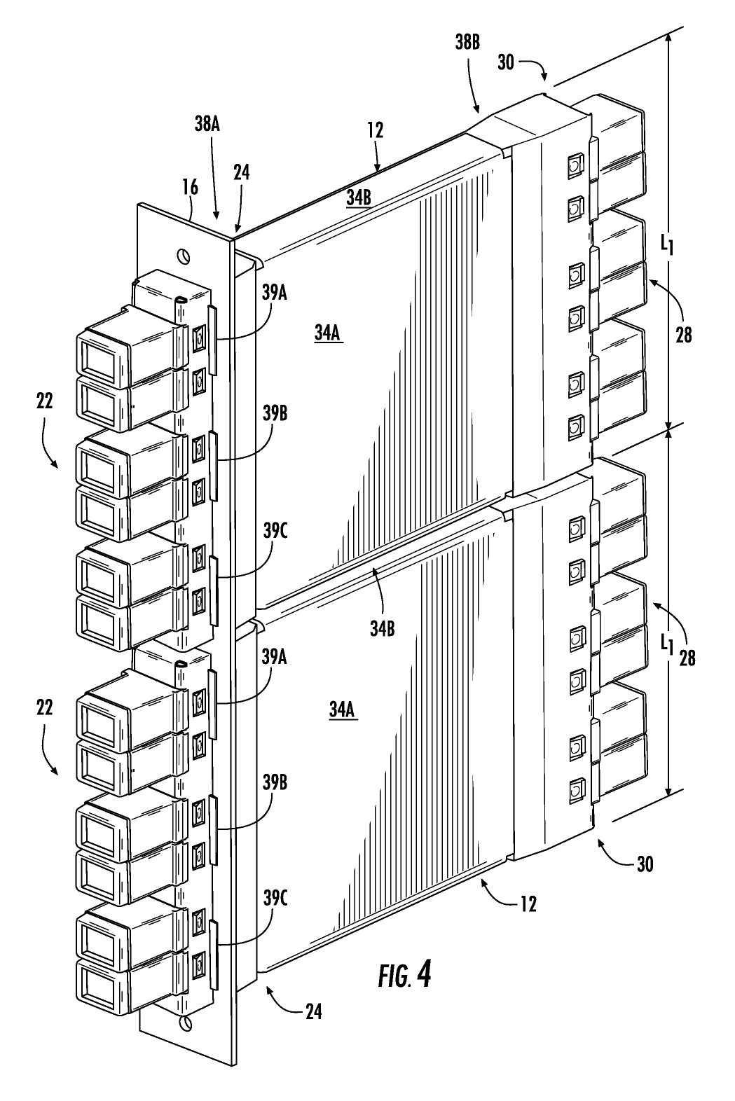

In this embodiment, the optical splitter modules 12 are disposed vertically in the fiber optic equipment housing 10 wherein the lengths L₁ of the optical splitter modules 12 are disposed along the Y-axis (Y₁) of the fiber optic equipment housing 10, as illustrated in FIG. 1. As will be discussed in more detail below with regard to FIGS. 3 and 4, the optical splitter modules 12 contain dimensions or a form factor comprised of at least one recessed portion. The recessed portion is configured to be received within a receiving area disposed in a mounting bracket 14. The mounting bracket is also compatible to be mounted to the fiber optic equipment housing 10. As a result, the optical splitter module 12 can be mounted in the fiber optic equipment housing 10 even if the form factor of the optical splitter module 12 is not compatible with the fiber optic equipment housing 10. In this embodiment, the mounting bracket 14 is provided in the form of a panel 16. The panel 16 is compatible to receive the at least one recessed portion disposed in the optical splitter module 12 and is also compatible to be installed with the fiber optic equipment housing 10. Thus, the panel 16 allows the optical splitter modules 12 to be compatibly installed in the fiber optic equipment housing 10. In this regard, the optical splitter module 12 may be compatible to be installed in different types of fiber optic equipment housings other than the fiber optic equipment housing 10 if a suitable mounting bracket compatible with such fiber optic equipment housings are provided.

In this embodiment, as will be described in more detail below with regard to FIGS. 3 and 4, the panels 16 are configured to support two optical splitter modules 12 stacked on top of each other over the height H₁ in the fiber optic equipment housing 10. Each optical splitter module 12 has a length equal to or smaller than 2-U size in this embodiment. In this manner, the optical splitting capacity that is supported by a particular panel 16 can be divided in half by disposing only one optical splitter module 12 in the panel 16. This allows additional splitting capacity to be added easily to the fiber optic equipment housing 10 after an initial installation. For example, if it were desired to provide thirty-three (33) 2×2 optical splitters in the fiber optic equipment housing 10 in FIG. 1, eleven (11) optical splitter modules 12 could be provided rather than providing six (6) optical splitter modules each having six (6) 2×2 optical splitters (i.e., could not provide five and one-half (5½) optical splitter modules that each supported six (6) 2×2 optical splitters).

The panels 16 can also be installed in the fiber optic equipment housing 10 without initially receiving the optical splitter modules 12 such that additional optical splitter modules 12 can be installed easily in the panels 16. In this manner, when an initial installation does not require the maximum amount of optical splitter modules 12 to be installed in the fiber optic equipment housing 10, additional optical splitter modules 12 can be installed in the panels 16 to add additional splitting capacity. As will also be discussed in more detail below, the panels 16 are configured to retain the optical splitter modules 12 so that the optical splitter modules 12 are prevented from being translated about the fiber optic equipment housing 10 when installed in the panels 16.

FIGS. 2A-2C illustrate a perspective, side, and top views, respectively, of the optical splitter modules 12 installed in the panels 16 installed in the fiber optic equipment housing 10 in FIG. 1 to provide more detail on an exemplary form factor design of the optical splitter modules 12. As illustrated in FIGS. 2A-2C, the optical splitter module 12 in this embodiment includes a module housing 18. At least one optical splitter 20 is positioned in the module housing 18. In this embodiment, the optical splitter 20 contains three (3) 2×2 optical splitters 20A, 20B, 20C, as illustrated in FIG. 2A. At least one input fiber optic adapter 22 is disposed in a first end 24 of the module housing 18 and is optically connected to an input of the optical splitter 20. In this embodiment, three (3) duplex FC input fiber optic adapters 22A, 22B, 22C are disposed in the first end 24 of the module housing 18, as illustrated in FIGS. 2A and 2B. The fiber optic adapters 22A, 22B, 22C are optically connected to inputs 26A, 26B, 26C of the optical splitters 20A, 20B, 20C. A plurality of duplex FC output fiber optic adapters 28A, 28B, 28C are disposed in a second end 30 of the module housing 18 opposite the first end 24. The optical splitters 20A, 20B, 20C are each configured to split optical signals carried over input optical fibers (not shown) connected to the input fiber optic adapters 22A, 22B, 22C into a plurality of optical signals provided to the output fiber optic adapters 28A, 28B, 28C, as illustrated in FIG. 2A. Note that the fiber optic adapters 22, 28 may be of types other than FC, including but not limited to LC, SC, ST, MTP, etc.

With continuing reference to FIGS. 2A-2C, a recessed portion 32 is disposed in and between the first end 24 and the second end 30 of the module housing 18. As will be discussed in more detail below, the recessed portion 32 is configured to be received in a receiving area of the mounting bracket 14, such as the panel 16, to be supported by the mounting bracket 14 when installed in a fiber optic equipment housing, such as the fiber optic equipment housing 10 in FIG. 1. In this embodiment, the recessed portion 32 is comprised of two recessed portions 32A, 32B disposed on sides 34A, 34B, respectively, of the module housing 18. Only two sides 34A, 34B, a long side 34A and a top side 34B, of the module housing 18 are illustrated in FIGS. 2A-2C, but it is understood that the module housing 18 is comprised of two other sides each parallel to sides 34A and 34B, respectively, that also form recessed portions in the module housing 18. In this manner, the recessed portions 32 are disposed around the entire periphery of the module housing 18 in a rectangular shape since the module housing 18 is rectangular-shaped. Any other shape can be provided. Further, disposing recessed portions 32 around an entire periphery of the module housing 18 is not required. In this embodiment, the recessed portions 32A, 32B also extend the entire length of the sides 34A, 34B of the module housing 18. As will be discussed in more detail below, the recessed portions 32A, 32B are configured to be received in a receiving area of the panel 16 to install the optical splitter module 12 in the panel 16.

The module housing 18 also includes beveled edges 36A, 36B disposed between the recessed portions 32A, 32B and end sides 38A, 38B of the module housing 18 disposed on the first end 24 and the second end 28 of the module housing 18, respectively. In this regard, the length L₁ of the end sides 38A, 38B is larger than the length L₂ of the recessed portion 32A, as illustrated in FIG. 2B. Further, a width W₁ of the end sides 38A, 38B is larger than a width W₂ of the recessed portion 32B, as illustrated in FIG. 2C. The recessed portions 32A, 32B can be configured to be received within receiving areas in the form of openings 40A, 40B in the panel 16, as illustrated in FIG. 3. The panel 16 is an elongated member that also contains attachment openings 42A, 42B configured to receive attachment devices (not shown) to attach the panel 16 to the fiber optic equipment housing 10, as illustrated in FIG. 1. For example, plunger attachment devices (not shown) may be disposed through the attachment openings 42A, 42B to attach the panel 16 to the fiber optic equipment housing 10. The panel 16 has an overall length L₃ and width W₃ in this embodiment with openings 40A, 40B disposed therein to receive attachment devices to attach the panel 16 to the fiber optic equipment housing 10. The overall length L₃ and width W₃ and the openings 40A, 40B are disposed in the panel 16 to make the panel 16 compatible to be installed in the fiber optic equipment housing 10 of FIG. 1.

The openings 40A, 40B disposed through the panel 16 are of length L₄ and width W₄ sufficient to receive the length L₁ and width W₁ of the end sides 38A, 38B of the module housing 18. Additional attachment devices or hardware are not necessary to secure the optical splitter module 12 to the panel 16. The length L₃ and width W₃ are configured to be either slightly larger than the length L₁ and width W₁ of the end sides 38A, 38B of the module housing 18. In this manner, as illustrated in the perspective view of FIG. 4, the openings 40A, 40B (FIG. 3) of the panel 16 can receive the recessed portions 32A, 32B of the optical splitter module 12 to support the optical splitter module 12 when the panel 16 is installed in the fiber optic equipment housing 10.

To limit the disposition of the optical splitter module 12, and more particular the module housing 18, through the openings 40A, 40B in the panel 16, stopping members 37A, 37B, 37C are disposed on the module housing 18, as illustrated in FIGS. 2A-2C. The stopping members 37A, 37B, 37C prevent the module housing 18 from being extended fully through the openings 40A, 40B in the panel 16, as illustrated in FIG. 4. Each stopping member 37A, 37B, 37C contains a lip portion 39A, 39B, 39C, respectively, that extends from the stopping members 37A, 37B, 37C and from the module housing 18 and are configured to engage with the panel 16 to prevent the optical splitter module 12 from extending through the openings 40A, 40B in the panel 16 beyond the lip portions 39A, 39B, 39C. As the module housing 18 is placed in the openings 40A, 40B in the panel 16 starting with the end side 38B, the module housing 18 is pushed back into the openings 40A, 40B until the panel 16 abuts the lip portions 39A, 39B, 39C. Tabs 41A, 41B, 41C also disposed on the stopping members 37A, 37B, 37C, respectively, will also engage the panel 16 on the opposite side from the lip portions 39A, 39B, 39C to secure the optical splitter module 12 in the opening 40 and to prevent translation of the module housing 18 when installed.

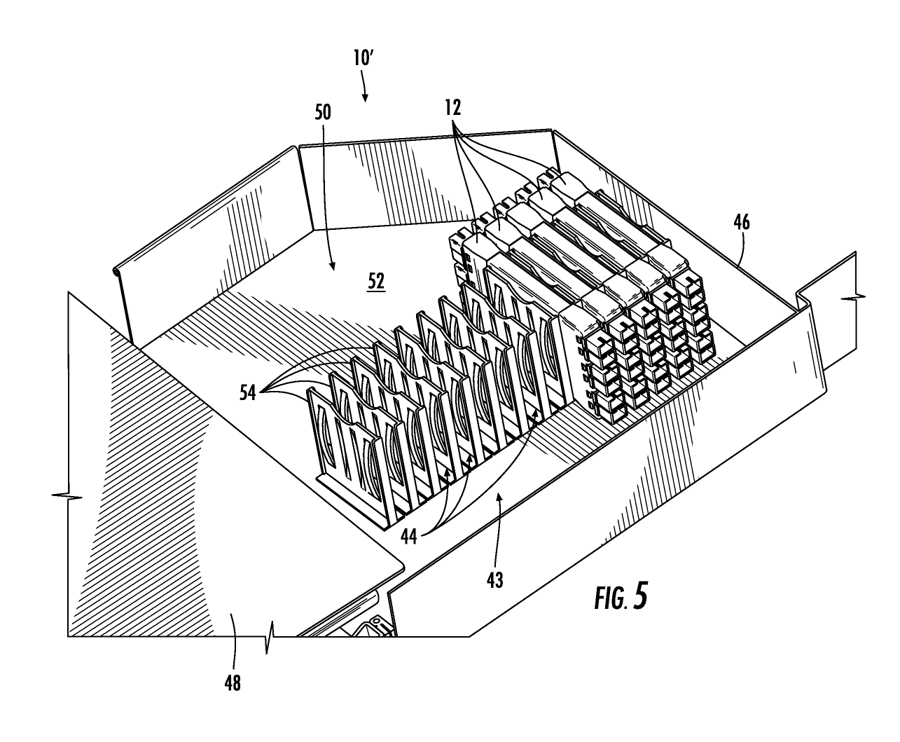

In summary for this embodiment, the panel 16 is compatible to receive the optical splitter modules 12 and compatible to be installed in the fiber optic equipment housing 10 of FIG. 1. In this regard, the optical splitter modules 12 do not have to be directly compatible to be installed in the fiber optic equipment housing 10. Thus, the optical splitter modules 12 may be configured to be universally installed in other types of fiber optic equipment housings. In this regard, FIG. 5 is a front perspective view of another exemplary fiber optic equipment housing 10′ in which the optical splitter modules 12 can also be installed. In this embodiment, the optical splitter modules 12 are the same optical splitter modules as provided in FIGS. 2A-2C and described above. However, by providing suitable mounting bracket assemblies 43 that include receiving areas 44 configured to receive the form factor of the optical splitter module 12 and also configured to be installed in the fiber optic equipment housing 10′, the optical splitter modules 12 can also be installed in the fiber optic equipment housing 10′. Thus, this is one example where the optical splitter module 12 can be installed in different types of fiber optic equipment housings.

As illustrated in FIG. 5, the fiber optic equipment housing 10′ receives the optical splitter modules 12 differently than the fiber optic equipment housing 10 in FIG. 1. In this embodiment, the fiber optic equipment housing 10′ provides a door or compartment 46 (hereinafter “compartment 46”) that is configured to swing out from a chassis 48 and contains an internal compartment 50 configured to receive fiber optic equipment, including the optical splitter modules 12 as shown. For example, the compartment 46 may be configured to swing out up to ninety (90) degrees from the chassis 48. A base 52 is disposed in the bottom of the internal compartment 50 that is configured to receive fiber optic equipment. With continuing reference to FIG. 5, the mounting bracket assemblies 43 that are configured to provide the receiving areas 44 to receive and support the optical splitter modules 12 are comprised of mounting brackets 54 installed opposing each other. The receiving areas 44 that receive the optical splitter modules 12 are formed between two opposing mounting brackets 54 installed in the base 52 of the internal compartment 50.

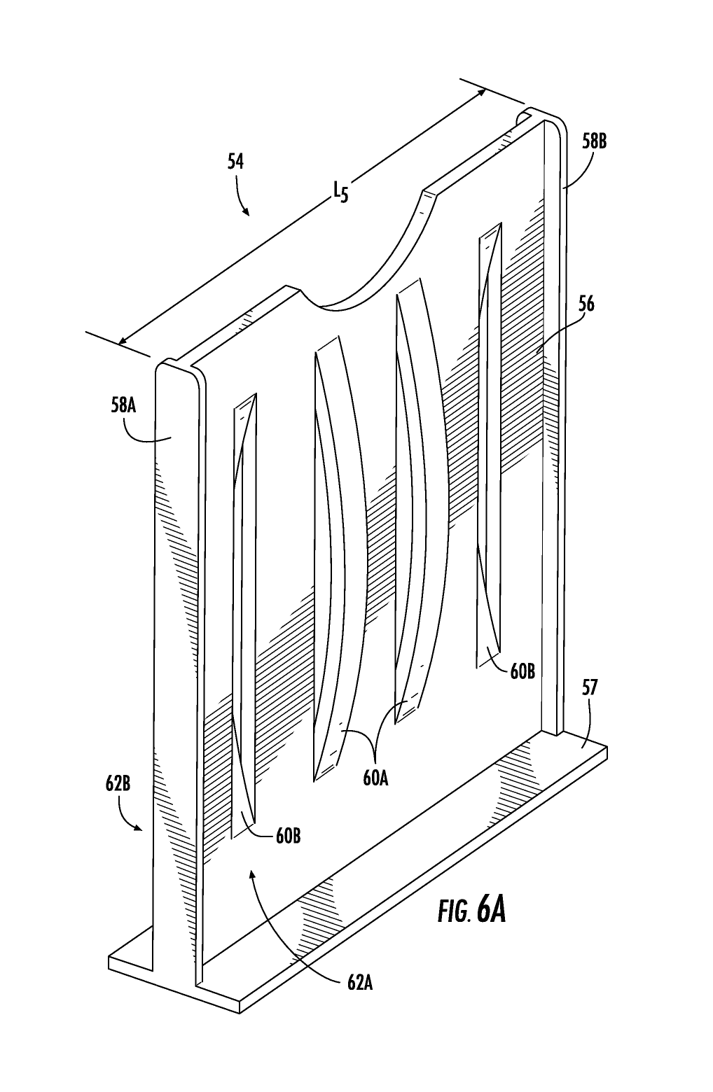

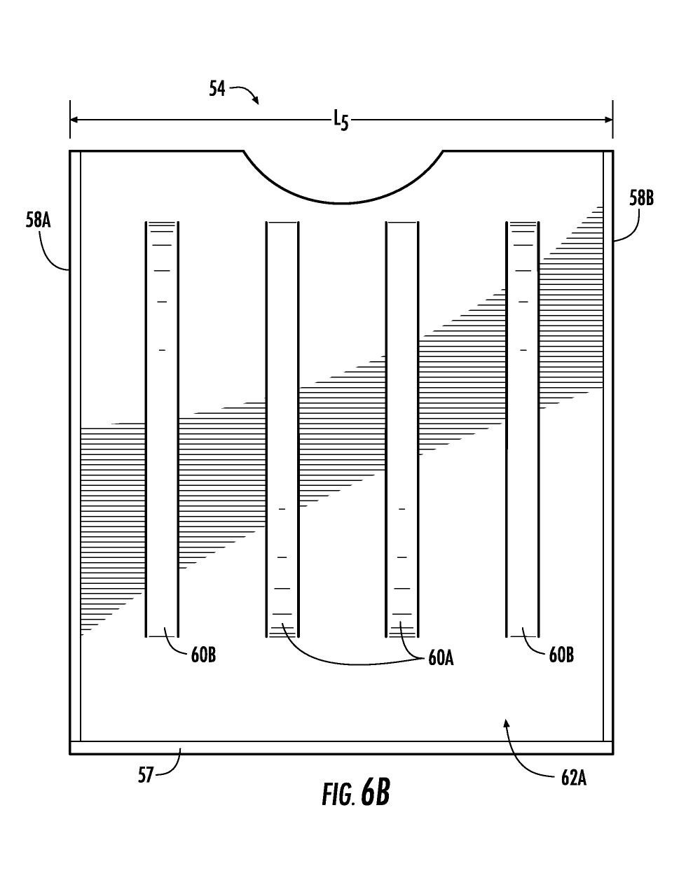

FIGS. 6A and 6B are perspective and front views, respectively, of the mounting brackets 54 to provide more detail for this embodiment. The mounting brackets 54 are comprised of an elongated portion 56 supported on a base 57. The base 57 is mounted to the base 52 of the internal compartment 50 of the fiber optic equipment housing 10′ to mount the mounting bracket 54 to the fiber optic equipment housing 10′. The elongated portion 56 contains two orthogonal members 58A, 58B disposed apart in length L₅, which slightly less than the length L₂ of the recessed portion 32A of the optical splitter module 12 (see FIG. 2B). In this manner, the recessed portions 32A, 32B fit within the orthogonal members 58A, 58B, but the beveled edges 36A, 36B of the optical splitter module 12 are disposed on the outside of the orthogonal members 58A, 58B.

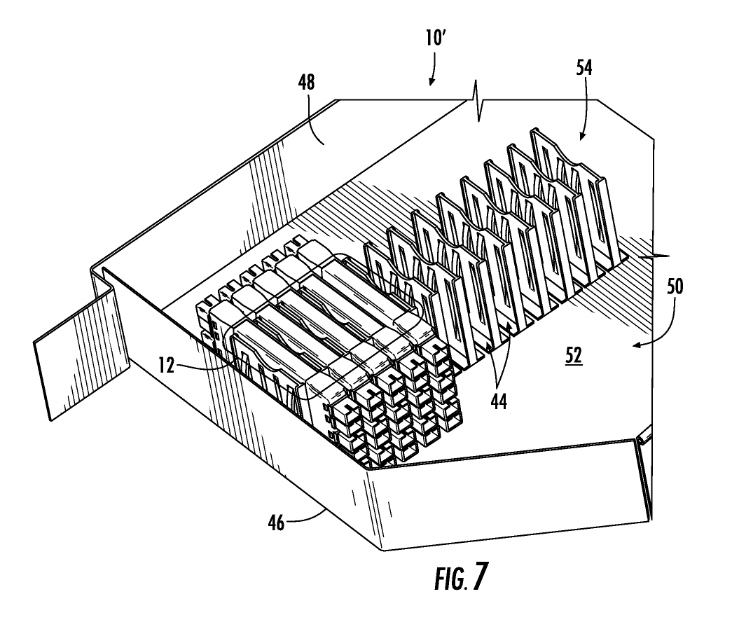

As illustrated in FIG. 5, the optical splitter module 12 is installed between two opposing mounting brackets 54 to secure the optical splitter module 12. As shown in FIG. 6A, leaf springs 60A, 60B are disposed through the mounting brackets 54 so that the recessed portion 32A of the optical splitter module 12 is secured by friction between two opposing mounting brackets 54. In this manner, separate attachment devices are not necessary to be employed to secure the optical splitter modules 12 between the mounting brackets 54. To remove the optical splitter module 12, a pulling force is applied to overcome the friction provided by the leaf springs 60A, 60B on the module housing 18 when the optical splitter module 12 is installed in the receiving area 44. To provide for the mounting bracket 54 to be universally used on either side of an optical splitter module 12, the leaf springs 60A, 60B are disposed on both sides 62A, 62B of the mounting bracket 54 in this embodiment. Typically, the optical splitter modules 12 are installed after the mounting brackets 54 are installed in the base 52 of the internal compartment 50 such that the sides 62A, 62B of the mounting brackets 54 are opposed to each other to provide the receiving area 44 for receiving optical splitter modules 12. FIG. 7 further illustrates a rear perspective view of the optical splitter modules 12 installed between the mounting brackets 54 of FIGS. 6A and 6B mounted in the fiber optic equipment housing 10′.

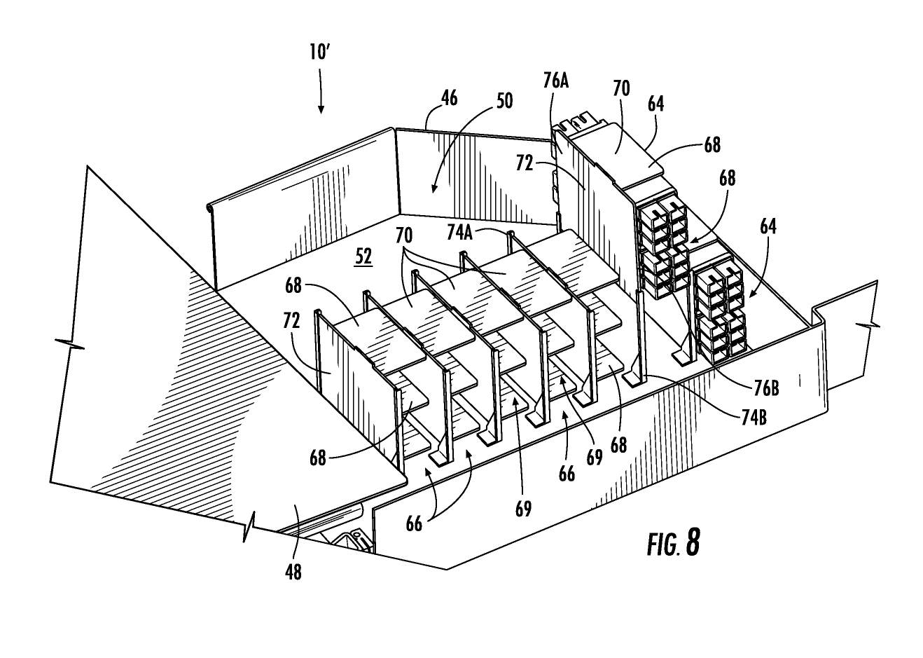

Alternative optical splitter modules can also be installed in the fiber optic equipment housing 10′ other than the optical splitter modules 12. Other universal optical splitter modules may be installed in the fiber optic equipment housing 10′ if a suitable mounting assembly can be provided that is compatible with the alternative optical splitter module and the fiber optic equipment housing 10′. In this regard, FIG. 8 is a front perspective view of alternative exemplary optical splitter modules 64 installed between alternative exemplary mounting assemblies 66 containing mounting platforms 68 and mounted in the fiber optic equipment housing 10′ of FIG. 5. As illustrated in FIG. 8, the mounting assemblies 66 can each contain multiple mounting platforms 68 that each are configured to support one optical splitter module 64. The space formed between mounting platforms 68 provides a receiving area 69 for receiving the optical splitter modules 64. The mounting assemblies 66 are comprised of mounting brackets 70 that each contain one or more mounting platforms 68 that extend generally orthogonally from a mounting bracket side 72 in this embodiment. To secure the mounting bracket 70 to the base 52 of the internal compartment 50, mounting guides 74A, 74B are provided in the base 52 that are configured to receive end sides 76A, 76B of the mounting bracket 70 to secure the mounting platforms 68 to the fiber optic equipment housing 10′. In this regard, the end sides 76A, 76B act as rails that are received and held in the mounting guides 74A, 74B.

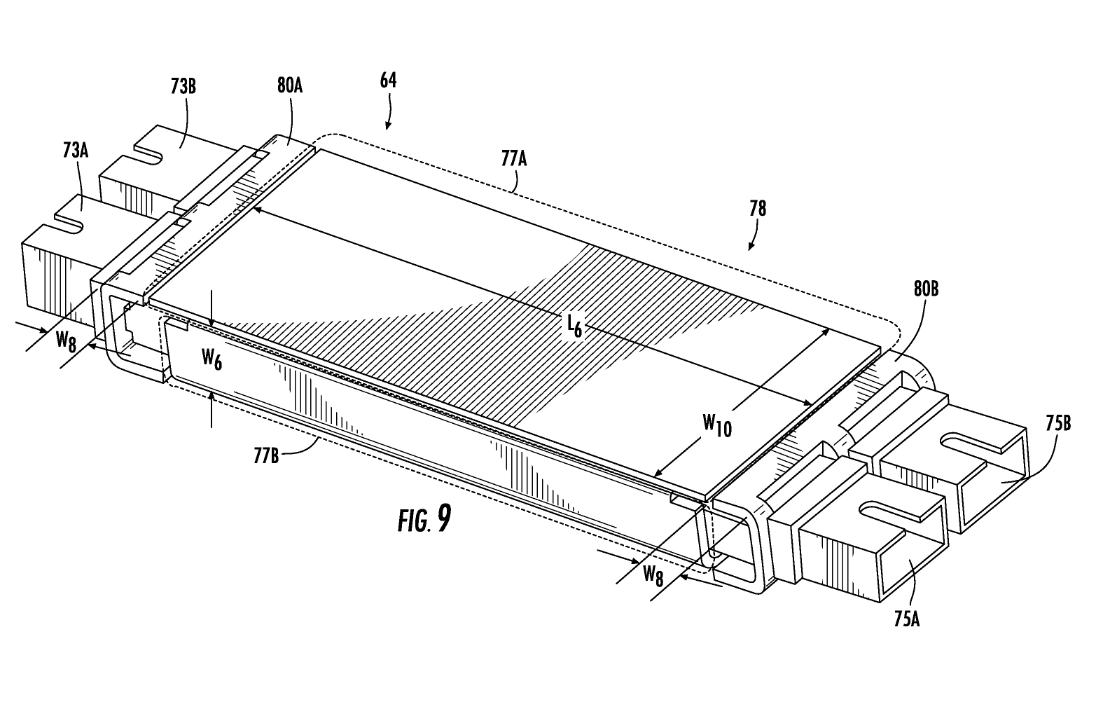

FIG. 9 is a perspective view of the optical splitter module 64 configured to be installed on the mounting platforms 68 in the mounting assembly 66 in FIG. 8. The optical splitter module 64 in this embodiment contains one (1) 2×2 optical splitter. The optical splitter module 64 is similar to the optical splitter module 12 in FIGS. 2A-2C in that it contains recessed portions 77A, 77B disposed in a module housing 78. Two input fiber optic adapters 73A, 73B are disposed in the module housing 78 that provide optical signals to an optical splitter (not shown) disposed within the module housing 78 to split such optical signals to optical fibers connected to output fiber optic adapters 75A, 75B also disposed in the module housing 78. The optical splitter and manner in which optical signals are split by the optical splitter inside the module housing 78 can be the same as provided in one (1) of the 2×2 channels disposed in the optical splitter module 12 in FIG. 2A, previously described.

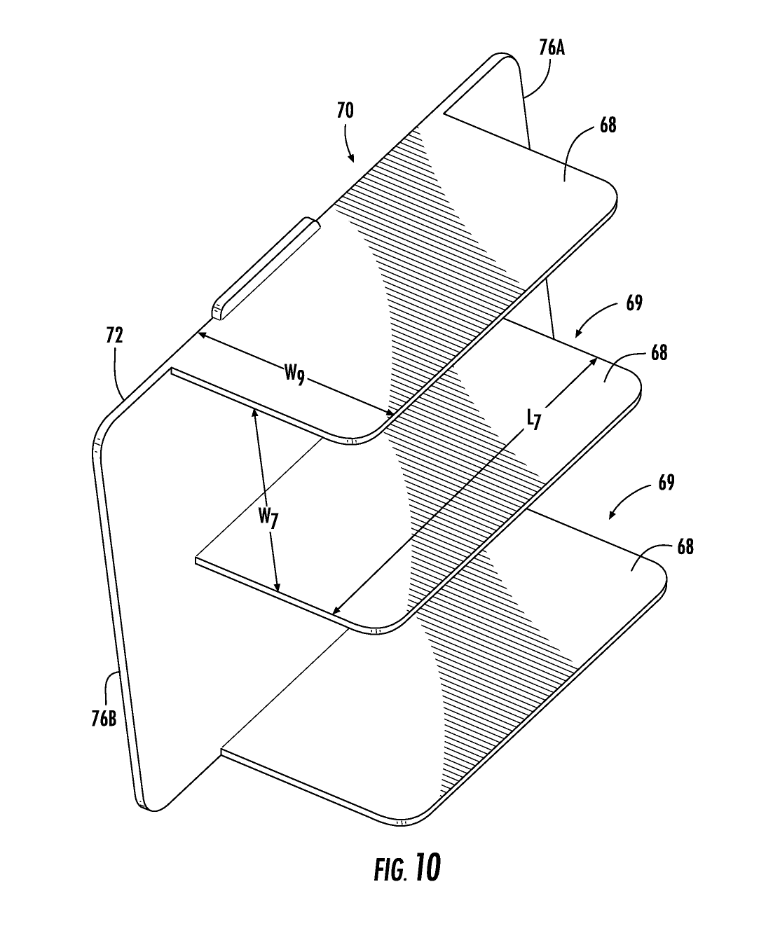

The recessed portions 77A, 77B disposed in the module housing 78 of the optical splitter module 64 are configured to be received in the receiving areas 69 formed between the mounting platforms 68 disposed in the mounting brackets 70, as illustrated in the perspective view of the mounting bracket 70 in FIG. 10. A length L₆ and width W₆ of the recessed portions 77A, 77B of the module housing 78, as illustrated in FIG. 9, are the same or slightly less than a length L₇ and width W₇ of the receiving area 69 formed by adjacent mounting platforms 68 disposed in the mounting bracket 70, as illustrated in FIG. 10. In this regard, a friction fit may be provided between the recessed portions 77A, 77B of the module housing 78 and adjacent mounting platforms 68. Thus, the optical splitter modules 64 can be disposed within the receiving area 69 in a friction fit without the need for separate attachment devices, if desired. Further, as illustrated in FIG. 8, when the optical splitter module 64, and more particularly the recessed portions 77A, 77B, are disposed between adjacent mounting platforms 68, non-recessed portions 80A, 80B of the optical splitter module 64, as illustrated in FIG. 9, are prevented from translating or moving into the receiving area 69. This is because a width W₈ of the non-recessed portions 80A, 80B, as illustrated in FIG. 9, is larger than the width W₇ between adjacent mounting platforms 68, as illustrated in FIG. 10. Further, it may be desired to provide a width W₉ of the mounting platform 68, as illustrated in FIG. 10, to be the same as or less than width W₁₀ of the module housing 78 so that another mounting bracket 70 can be disposed immediately adjacently, as illustrated in FIG. 9.

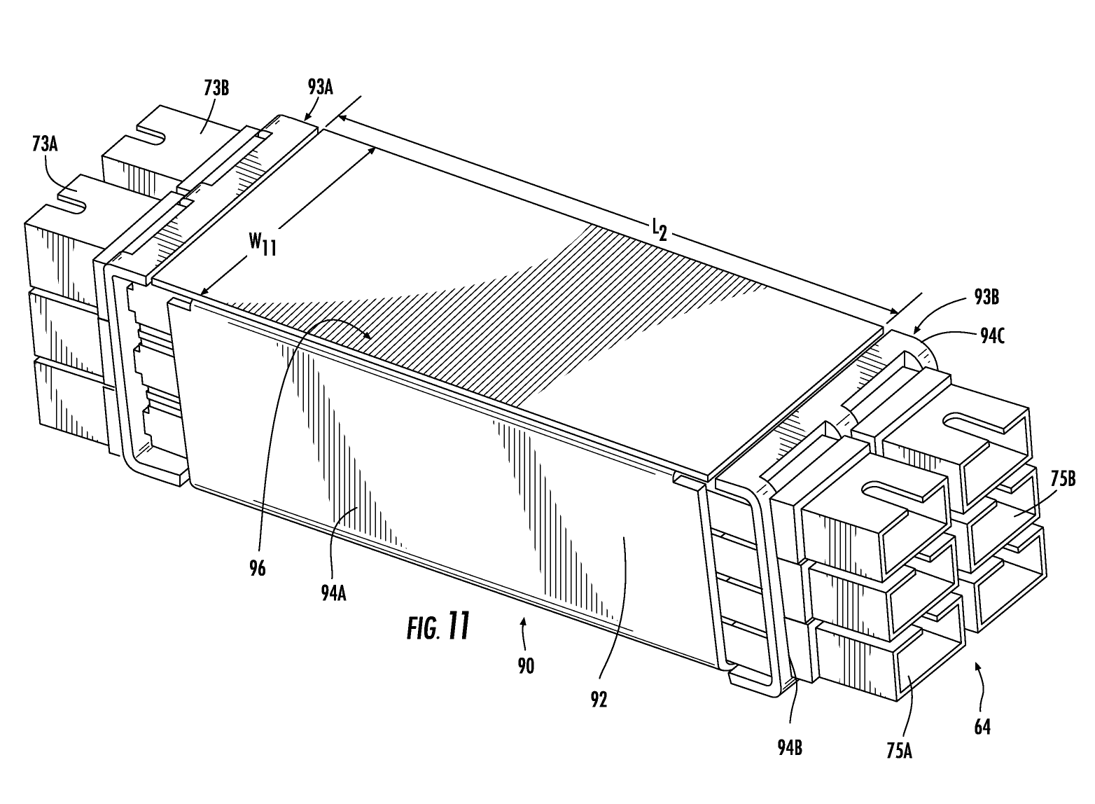

FIG. 11 illustrates an alternative mounting assembly 90 that can also be provided to compatibly receive the optical splitter modules 64 of FIG. 9 and be mounted in the fiber optic equipment housing 10′ of FIG. 8. In this embodiment, the mounting assembly 90 is comprised of a lift-up carrier 92. The lift-up carrier 92 in this embodiment is comprised of three sides 94A, 94B, 94C arranged in a U-shape to provide an open receiving area 96 for receiving the optical splitter modules 64. In this regard, an internal width W₁₁ of the lift-up carrier 92 is either slightly smaller, the same, or slightly larger than the width W₉ of the recessed portion 77A to provide the receiving area 96 and to provide a friction fit between the optical splitter modules 64 and the lift-up carrier 92. Thus, no attachment devices are necessary to secure the optical splitter modules 64 to the lift-up carrier 92 in this embodiment. The length L₈ of the lift-up carrier 92, as illustrated in FIG. 11, is also designed to provide for non-recessed portions 93A, 93B of the module housing 78 and the fiber optic adapters 73A, 73B, 75A, 75B to be located outside of the receiving area 96 so that the optical fiber modules 64 cannot translate in the lift-up carrier 92, when installed in the receiving area 96.

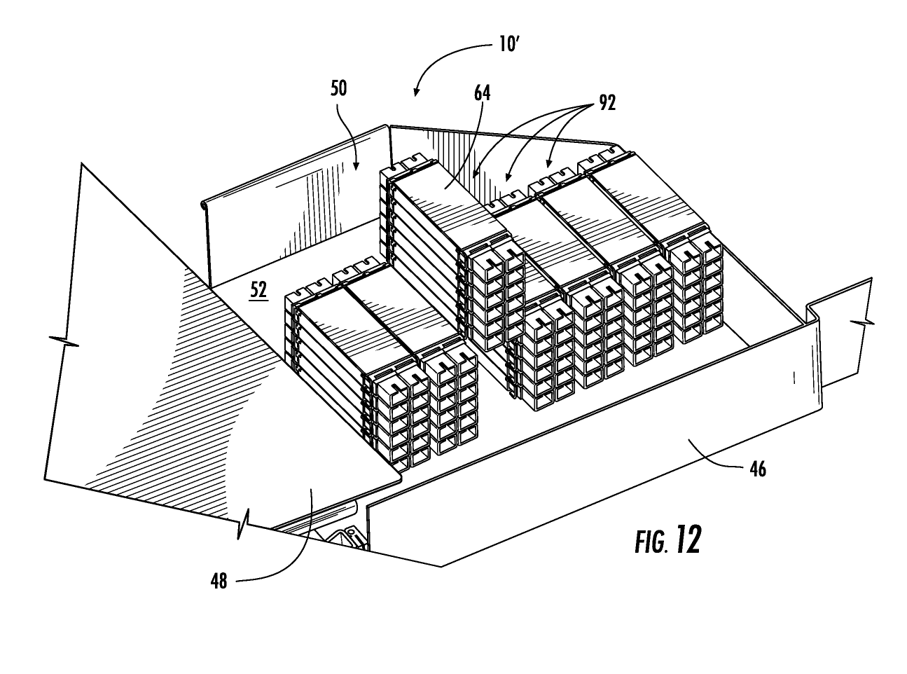

Once the desired number of optical splitter modules 64 are loaded in a stacked fashion in the lift-up carrier 92, as illustrated in FIG. 11, the lift-up carrier 92 can be installed and secured in the base 52 of the internal compartment 50 of the fiber optic equipment housing 10′, as illustrated in FIG. 12, to install and secure the optical splitter modules 64 in the fiber optic equipment housing 10′. The optical splitter modules 64 can be removed by lifting the optical splitter modules 64 out of the lift-up carrier 92, or by removing the entire lift-up carrier 92 from the base 52 of the fiber optic equipment housing 10′.

Many modifications and other embodiments of the invention set forth herein will come to mind to one skilled in the art to which the invention pertains having the benefit of the teachings presented in the foregoing descriptions and the associated drawings. These modifications include, but are not limited to, the type of optical splitter module, the form factor, the number or size of recessed portions, the number of optical splitters or splitting capacity provided, the type of mounting assembly or mounting brackets employed, and/or the type or form factor or size of fiber optic equipment housings designed to support mounting assemblies and optical splitter modules. Further, as used herein, it is intended that the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

Although the disclosure has been illustrated and described herein with reference to certain embodiments and specific examples thereof, it will be readily apparent to those of ordinary skill in the art that other embodiments and examples can perform similar functions and/or achieve like results. It is to be understood that the invention is not to be limited to the specific embodiments disclosed and that modifications and other embodiments are intended to be included within the scope of the appended claims. It is intended that the present disclosure cover the modifications and variations of this invention provided they come within the scope of the appended claims and their equivalents. All such equivalent embodiments and examples are within the spirit and scope of the disclosure and are intended to be covered by the appended claims. Thus, it is intended that the present disclosure cover the modifications and variations disclosed herein provided they come within the scope of the appended claims and their equivalents. Although specific terms are employed herein, they are used in a generic and descriptive sense only and not for purposes of limitation.

What is claimed is:

1. An optical splitter module, comprising:
a module housing;
an optical splitter positioned in the module housing;
at least one input fiber optic adapter disposed in a first end of the module housing and optically connected to an input of the optical splitter;
a plurality of output fiber optic adapters disposed in a second end of the module housing opposite of the first end of the module housing;
wherein the optical splitter is configured to split an optical signal carried over an input optical fiber connected to the at least one input fiber optic adapter into a plurality of optical signals provided to the plurality of output fiber optic adapters; and
at least one recessed portion disposed in the module housing between the first end and the second end.

2. The optical splitter module of claim 1, wherein the module housing is configured to be received within a mounting assembly.

3. The optical splitter module of claim 1, wherein the at least one recessed portion is configured to be received within a mounting assembly.

4. The optical splitter module of claim 1, wherein the module housing is configured to prevent translation of the module housing within a mounting assembly.

5. The optical splitter module of claim 1, wherein the at least one recessed portion extends across an entire length of a side of the module housing.

6. The optical splitter module of claim 1, wherein the at least one recessed portion extends across an entire width of a top of the module housing.

7. The optical splitter module of claim 1, wherein the at least one recessed portion is disposed around a periphery of the module housing.

8. The optical splitter module of claim 1, further comprising at least one beveled edge disposed between the at least one recessed portion and at least one of the first end and the second end.

9. The optical splitter module of claim 1, further comprising at least one stopping member disposed on the module housing configured to engage with a mounting assembly to prevent the module housing from being extended in the mounting assembly beyond the at least one stopping member.

10. The optical splitter module of claim 9, wherein the at least one stopping member further comprises at least one lip portion configured to engage with the mounting assembly.

11. An optical splitter assembly, comprising:
one or more optical splitter modules each comprising:
a module housing;
an optical splitter positioned in the module housing; and
at least one recessed portion disposed in the module housing between a first end of the module housing and a second end of the module housing opposite the first end of the module housing; and
at least one mounting assembly forming at least one receiving area configured to receive the module housing of at least one of the one or more optical splitter modules.

12. The optical splitter assembly of claim 11, wherein the at least one recessed portion is configured to be received in the at least one receiving area.

13. The optical splitter assembly of claim 11, wherein the module housing is configured to prevent translation of the module housing in the mounting assembly.

14. The optical splitter assembly of claim 11, wherein a width of the at least one receiving area is less than a width of the front end and the second end of the module housing.

15. The optical splitter assembly of claim 11, further comprising at least one stopping member disposed on the module housing configured to engage with the at least one mounting assembly to prevent the module housing from being extended in the at least one mounting assembly beyond the at least one stopping member.

16. The optical splitter assembly of claim 11, wherein the at least one mounting assembly is comprised of a panel, wherein the at least one receiving area is comprised of a first opening disposed in the panel.

17. The optical splitter assembly of claim 16, wherein the one or more optical splitter modules are comprised of two optical splitter modules, wherein the at least one receiving area is further comprised of a second opening disposed in the panel configured to receive a second recessed portion of a second optical splitter module among the two optical splitter modules.

18. The optical splitter assembly of claim 16, further comprising at least one attachment opening disposed in the panel configured to receive an attachment device to attach the panel to a fiber optic equipment housing.

19. The optical splitter assembly of claim 11, wherein the at least one mounting assembly is comprised of at least two opposing mounting brackets, wherein the at least one receiving area is formed between the at least two opposing mounting brackets.

20. The optical splitter assembly of claim 19, further comprising at least one leaf spring in the at least two opposing mounting brackets.

21. The optical splitter assembly of claim 19, further comprising a platform disposed in each of the at least two opposing mounting brackets configured to mount the at least two opposing mounting brackets to a fiber optic equipment housing.

22. The optical splitter assembly of claim 11, wherein the mounting assembly is comprised of a mounting bracket containing at least two opposing mounting platforms each extending from a mounting bracket side, wherein the at least one receiving area is formed between the at least two opposing mounting platforms.

23. The optical splitter assembly of claim 22, wherein the mounting assembly further comprises at least two opposing mounting guides configured to be attached to a fiber optic equipment housing and configured to receive end sides of the mounting bracket side to secure the at least two opposing mounting platforms to the fiber optic equipment housing.

24. The optical splitter assembly of claim 11, wherein the at least one mounting assembly is comprised of a lift-up carrier providing the at least one receiving area.

25. A method for installing an optical splitter module in a fiber optic equipment housing, comprising:
providing a module housing having at least one recessed portion disposed between a first and second end of the module housing;
disposing the module housing into a receiving area of a mounting assembly; and
installing the mounting assembly in the fiber optic equipment housing.

26. The method of claim 25, wherein the disposing further comprises disposing the at least one recessed portion into the receiving area of the mounting assembly.

27. The method of claim 54, further comprising disposing a second recessed portion disposed in a second module housing of the optical splitter module between a first end of the second module housing and a second end of the second module housing opposite the first end of the second module housing into a second receiving area of the mounting assembly.

28. The method of claim 25, wherein disposing the at least one recessed portion comprises disposing the at least one recessed portion in the receiving area comprised of an opening in a panel provided in the mounting assembly.

29. The method of claim 25, wherein disposing the at least one recessed portion comprises disposing the at least one recessed portion in the receiving area formed between at least two opposing mounting brackets provided in the mounting assembly

30. The method of claim 25, wherein disposing the at least one recessed portion comprises disposing the at least one recessed portion in the receiving area formed between at least two opposing mounting platforms each extending orthogonally from a mounting bracket side provided in the mounting assembly.

31. The method of claim 25, wherein disposing the at least one recessed portion comprises disposing the at least one recessed portion in the receiving area formed inside a lift-up carrier.
